(19) United States
(12) Patent Application Publication
(10) Pub. No.: US 2011/0279031 A1
(43) Pub. Date: Nov. 17, 2011

(54) High pressure discharge lamp

(75) Inventor: Klaus Stockwald, Germering (DE)

(73) Assignee: OSRAM GESELLSCHAFT MIT BESCHRAENKTER HAFTUNG, Muenchen (DE)

(21) Appl. No.: 13/146,409

(22) PCT Filed: Feb. 2, 2010
(86) PCT No.: PCT/EP10/51223

§ 371 Date: Jul. 27, 2011

(30) Foreign Application Priority Data
Feb. 20, 2009 (DE) 10 2009 009 890.9

(51) Int. Cl. H01J 61/20; H01J 61/16; H01J 61/18

(52) U.S. Cl. 313/641; 313/638; 313/642

(57) ABSTRACT

In various embodiments, a high pressure discharge lamp may include a ceramic discharge vessel which contains two electrodes and a metal halide filling in a discharge volume V, wherein the filling contains a starting gas that is selected individually or in mixture from the group of the noble gases, wherein the filling moreover contains metal halides that are selected individually or in mixture from the group MXn, M being a representative from the group In, Zn, Mg, Mn, Al, Tl, Sn, Sc, Hg and X being a representative from the group I, Br, Cl, wherein moreover the filling contains a stoichiometric excess of the metallic portion M in relation to MXn, wherein the concentration of the metallic portion is in the range from 0.1 to 20 mg/cm³.

### TECHNICAL FIELD

The invention takes as its starting point a high pressure discharge lamp in accordance with the preamble of claim 1. These lamps are intended for general lighting.

### PRIOR ART

DE 25 19 377 and EP 57 093 disclose lamps in which Hg and HgI2 are used simultaneously, wherein further metal halides such as iodides of Na, Tl and Ca are also used. Such lamps are used for photo-optical purposes.

### SUMMARY OF THE INVENTION

The present invention addresses the problem of providing a high pressure discharge lamp which has a metal halide filling and is suitable for general lighting, being readily capable of hot starting.

This problem is solved by the characterizing features of claim 1.

Particularly advantageous embodiments are found in the dependent claims.

Existing metal halide lamps are only capable of hot restarting if a high starting voltage is applied (typically <10-15 kVpk).

This is essentially due to the high Hg pressure, the volatile metal halide components and the high burner temperature, and to the temporal profile thereof following the switch-off procedure.

This limits the usability, requires structural insulation measures (needing considerable space) and significantly restricts the miniaturization of the lamps.

Ceramic lamps having a high starting voltage were previously started by means of hot-start devices.

Base socket systems must be dimensioned in accordance with the required insulation lengths.

According to the invention, metal halide fillings are used in ceramic metal halide-lamps with elementary metallic additives, such that the Hg dose is considerably less than a value of typically 50 mg/ccm, preferably using a dose of <10-1 mg/ccm.

In addition to Hg, suitable metallic additives are metals that readily combine with I, Br, Cl to form volatile metal halides which are also filled in the lamp as a metal halide, e.g. In, Zn, Mg, Mn, Al, Tl, Sc. A typical dose is 0.1-15 mg/ccm.

In order to improve the light color and the red fraction, MH additives of Li, Na, Ca can also be used. MH can be enriched by Hg halides (e.g. Hg12, HgBr2, HgCl2) such that a maintaining voltage can be set in an extended range.

The initial gas pressure (typically Ar noble gases or a mixture thereof) of the lamps is 15-1000 mbar.

The lamps exhibit a rapid drop in the hot-restart voltage and allow hot restarting in response to higher resonant starting voltages <6 kVpk using external starting aids.

The invention relates in particular to ceramic metal halide lamps of low and medium power (up to approximately 250 W) having a good hot-starting capability.

Specific exemplary embodiments are as follows:

The lamp contains filling components having particularly good hot-starting capability, i.e. their starting voltage decreases to a considerably greater extent after the lamp is switched off.

In particular, the invention relates to the use of metal halide fillings in ceramic discharge vessels having elementary metallic additives, such that the Hg dose is less than a value of typically <50 mg/ccm and preferably approximately <10-1 mg/ccm. It should ideally be less than 1 mg/cm³.

Suitable metallic additives (in addition to Hg) are metals M that readily form volatile metal halides MXn (where X=I, Br, Cl), which are also filled in the lamp as a metal halide, e.g. In, Zn, Mg, Mn, Al, Tl, Sn, Sc.

In this case, the metal halide filling can be enriched in particular by Hg halides HgX2 (e.g. HgI2, HgBr2, HgCl2) such that the maintaining voltage can be set in an extended range.

The initial gas pressure (typically Ar, heavier noble gases or a mixture thereof) of the lamps is 15-1000 mbar cold.

A typical dose of the elementary metal component is 0.1-15 mg/ccm depending on the metal type.

In order to improve the light color and the red fraction, metal halides of Li, Na, Ca can also be used as additives, either individually or in mixture.

The initial gas pressure (typically Ar, noble gases or a mixture thereof) of the lamps is in particular 25-1000 mbar.

Typical volumes of the ceramic discharge vessel are shown in Table 1.

TABLE 1
Reference volumes for ceramic discharge vessels

| | | Light | | | |
|---|---|---|---|---|---|
| No. | Wattage | color | V_{ref} [mm³] | Hg qty/mg | Hg mg/ccm |
| 1 | 20 W | warm white | 76.40 | 3.6 | 47.1 |
| 2 | 35 W | warm white | 158.79 | 2.6 | 16.4 |
| 3 | 70 W | warm white | 374.30 | 5.5 | 14.7 |

### EXAMPLES

Hot-restart ceramic discharge vessel with bulbous contour:
20-W lamp having a burner volume of 80 mm³:
Filling components: Hg
35-W lamp 160 mm³
70-W lamp 375 mm³
70-W examples having little or little/no Hg portion with/In halide/metallic Zn additive.

The lamp design can include conductive starting aids in the outer tube (e.g. capacitive conductor guides, which are sintered on or pressure-bonded and create a capacitive coupling of the electrode potentials on the outer wall of the discharge bulb, thereby generating excessive field strengths in the regions of the electrode tips or along the electrode leadthrough duct).

### BRIEF DESCRIPTION OF THE DRAWINGS

The invention is described in greater detail below with reference to a plurality of exemplary embodiments, wherein:

FIG. 1 shows a high pressure discharge lamp with discharge vessel;

FIGS. 2-5 show further exemplary embodiments.

### PREFERRED EMBODIMENT OF THE INVENTION

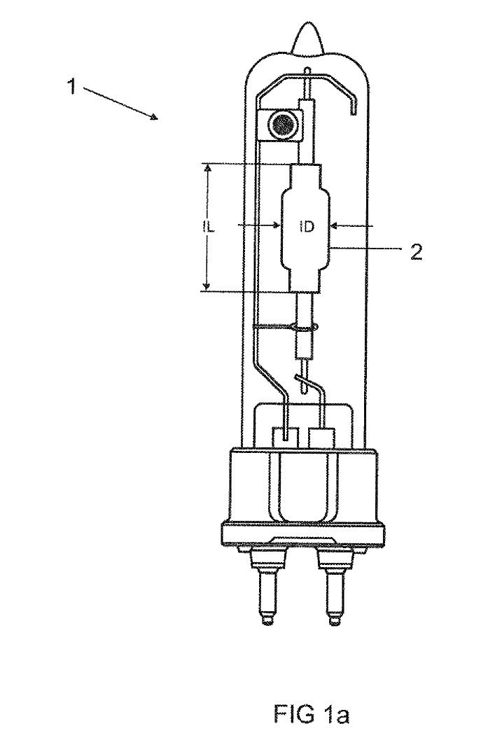

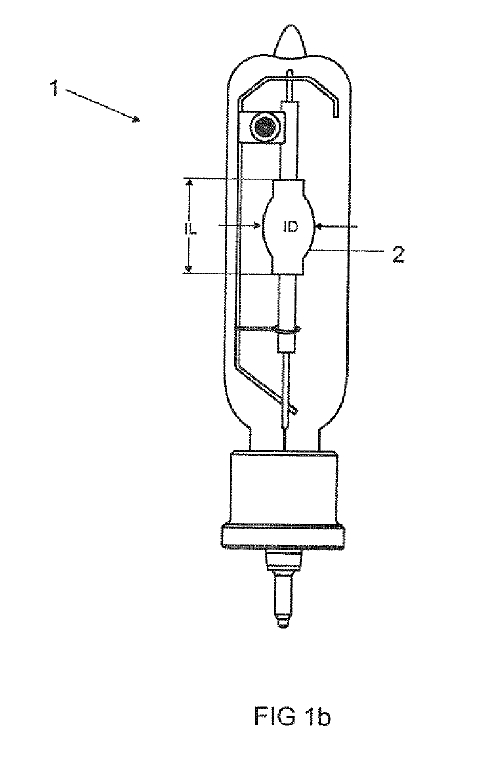

FIGS. 1a and 1b each show a discharge lamp 1 in schematic form. It is essentially a ceramic lamp. The discharge vessel 2 of Al2O3 ceramic has a specified inner diameter ID, e.g. 2 to 5 mm inner diameter ID, and a specified inner length IL, e.g. 10 to 15 mm inner length IL. The filling contains e.g. NaI, NaBr, InBr, InI, CeI3, CeBr3, Xe, HgI2 and Hg. The discharge vessel contains two opposing electrodes.

The discharge vessel is long (FIG. 1a) with rounded-off ends or bulbous (FIG. 1b).

The lamp has an outer tube and a ceramic base.

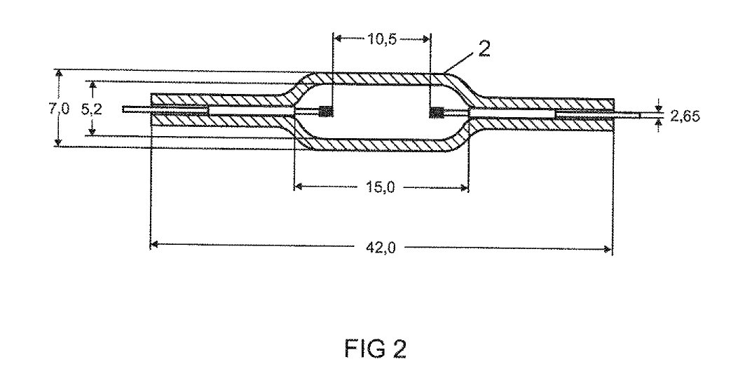

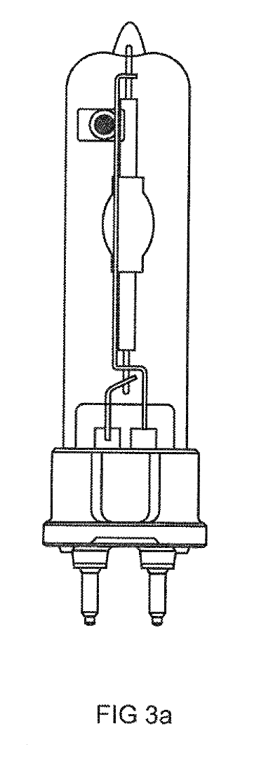

FIG. 2 shows a long rounded-off discharge vessel 2 in detail with dimensions.

Table 2a shows a plurality of fillings for discharge vessels as per FIG. 2. Table 2b shows fillings for discharge vessels having a bulbous shape. Table 3 shows the composition of a molten material for Table 2a.

Table 4 shows fillings for elliptical discharge vessels.

Table 5 shows molten material compositions for the fillings from Table 4.

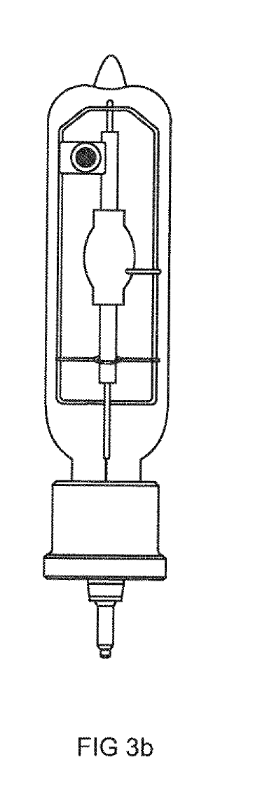

FIG. 3 shows illustrations of a further exemplary embodiment of a lamp in two views rotated by 90° (FIGS. 3 and 3b).

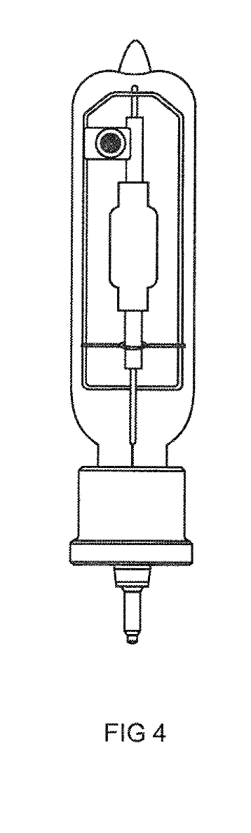

FIG. 4 shows a lamp comprising a long rounded-off discharge vessel in an evacuated outer tube.

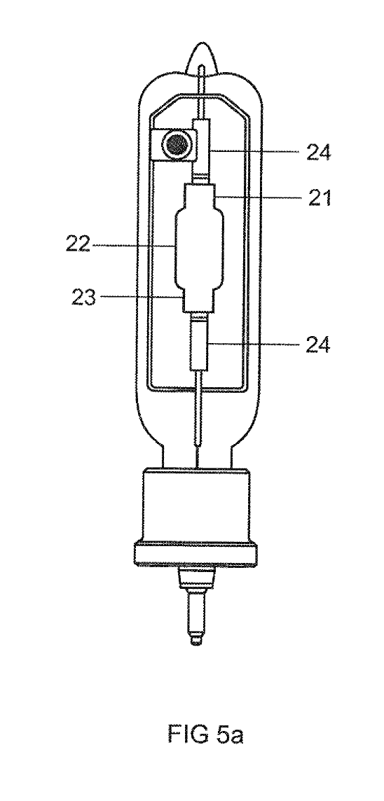

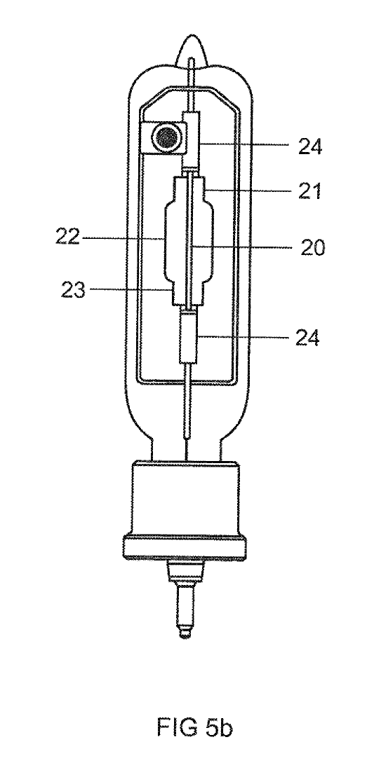

FIG. 5 shows two lateral views (these being rotated by 90°) of a lamp comprising starter strips 20 made of Pt, which is connected along the outside of the discharge vessel. It runs parallel with the axis and extends from the first end 21 over the discharge volume 22 to the second end 23. Capillary tubes 24 are attached at the end in each case.

TABLE 2b
Fillings in Zn lamps

| | | | | Fill | Fill | Comment |
|---|---|---|---|---|---|---|
| No. | Filling 1 | Filling 2 | Hg | pressure | gas | With Nb |
| V-1 | MHS 8 mg | Zn 3.0 mg | 0.0 | 1000 mbar | Xe | 12 mm Eo- |
| | | | | | | Abst + |
| | | | | | | std. frame |
| V-2 | MHS 8 mg | Zn 3.0 mg | 0.0 | 1000 mbar | Xe | Simple |
| | | InI 0.3 mg | | | | starting aid |
| | | | | | | wire |
| V-3 | MHS 7 mg | Zn 3.0 mg | 0.0 | 1000 mbar | Xe | Uniform |
| | | MnI2 1 mg | | | | melting |

TABLE 3
Example MH filling
Molten material composition

| Molten material | Component | % by weight |
|---|---|---|
| MHS | CaI2 | 34.60 |
| | CeI3 | 4.20 |
| | NaI | 58.10 |
| | TlI | 3.10 |

TABLE 2a

| | | | | Molar masses | | | | | | | |
|---|---|---|---|---|---|---|---|---|---|---|---|
| | | | | 200.6 | | 26.98 | | 114.82 | | 24.31 | |
| | | | V | Hg | cHg | Al | cAl | In | cIn | Mg | cMg |
| No. | Wattage | Type | [mm³] | mg | mg/ccm | mg | mg/ccm | mg | mg/ccm | mg | mg/ccm |
| 1 | 20 | TC | 80 | 2.6 | 32.5 | 0.1 | 1.25 | 0.5 | 6.3 | 0.1 | 1.25 |
| 2 | 35 | TC | 160 | 3.6 | 22.5 | 0.1 | 0.625 | 0.5 | 3.1 | 0.1 | 0.625 |
| 3 | 70 | TC | 375 | 5.5 | 14.7 | 0.3 | 0.8 | 0.5 | 1.3 | 0.3 | 0.8 |

| | | | | Molar ratios: | | | | | | | |
|---|---|---|---|---|---|---|---|---|---|---|---|
| | | | | Hg | cHg | Al | cAl | In | cIn | Mg | cMg |
| No. | | | | μmol | μmol/ccm | μmol | μmol/ccm | μmol | μmol/ccm | μmol | μmol/ccm |
| 1 | 20 | TC | 80 | 13.0 | 162.0 | 3.7 | 46.3 | 4.4 | 54.4 | 4.1 | 51.4 |
| 2 | 35 | TC | 160 | 17.9 | 112.2 | 3.7 | 23.2 | 4.4 | 27.2 | 4.1 | 25.7 |
| 3 | 70 | TC | 375 | 27.4 | 73.1 | 11.1 | 29.7 | 4.4 | 11.6 | 12.3 | 32.9 |

Molar ratios:

| | 54.94 | | 204.38 | | 118.71 | | 65.39 | |
|---|---|---|---|---|---|---|---|---|
| | Mn | cMn | Tl | cTl | Sn | cSn | Zn | |
| No. | mg | mg/ccm | mg | mg/ccm | mg | mg/ccm | mg | mg/ccm |
| 1 | 0.1 | 1.25 | 0.1 | 1.25 | 0.1 | 1.25 | 1 | 12.5 |
| 2 | 0.1 | 0.625 | 0.1 | 0.625 | 0.1 | 0.625 | 1 | 6.25 |
| 3 | 0.3 | 0.8 | 0.3 | 0.8 | 0.3 | 0.8 | 1 | 2.667 |

| | Molar ratios: | | | | | | | |
|---|---|---|---|---|---|---|---|---|
| | Mn | cMn | Tl | cTl | Sn | cSn | Zn | cZn |
| No. | μmol | μmol/ccm | μmol | μmol/ccm | μmol | μmol/ccm | μmol | μmol/ccm |
| 1 | 1.8 | 22.8 | 0.5 | 6.1 | 0.8 | 10.5 | 15.3 | 105.3 |
| 2 | 1.8 | 11.4 | 0.5 | 3.1 | 0.8 | 5.3 | 15.3 | 52.6 |
| 3 | 5.5 | 14.6 | 1.5 | 3.9 | 2.5 | 6.7 | 15.3 | 22.5 |

TABLE 4

| | | | | | | | Comment |
|---|---|---|---|---|---|---|---|
| Burner | Box | | | | | | With Nb 9.5 |
| type | mark | Lamp No. | Filling 1 | Filling 2 | Hg | Fill gas | mm Eo-Abst |
| Elliptical | l | 144/3-1 | MHS 8-61 | TlI 1.0 mg/1.0 | 0 | Ar | +symmetrical |
| | | | 1.2 mg | MHS 8-52 5 mg | | | frame |
| Elliptical | 2 | 144/3-2 | MHS 8-61 | TlI 1.0 mg/0.98 | 0 | Ar | |
| | | | 1.2 mg | MHS 8-52 5 mg | | | |
| Elliptical | 3 | 144/6-1 | MHS 8-61 | TlI 1.0 mg | 0 | Ar | |
| | | | 1.35 mg | MHS 8-53 5 mg | | | |
| Elliptical | 4 | 144/6-2 | MHS 8-61 | TlI 1.0 mg | 0 | Ar | |
| | | | 1.35 mg | MHS 8-53 5 mg | | | |
| Elliptical | 1 | 144/8-1 | MHS 8-61 | TlI 1.0 mg | 0 | Ar | |
| | | | 1.3 mg | MHS 8-65 5 mg | | | |
| Elliptical | 2 | 144/8-2 | MHS 8-61 | TlI 1.0 mg | 0 | Ar | |
| | | | 1.3 mg | MHS 8-65 5 mg | | | |
| Elliptical | 3 | 150/4-1 | MHS 8-61 | MHS 8-59 1.0 mg | 0 | Ar | |
| | | var | 1.3 mg | MHS 8-53 4 mg | | | |
| Elliptical | 4 | 150/4-2 | MHS 8-61 | MHS 8-59 1.0 mg | 0 | Ar | |
| | | var | 1.3 mg | MHS 8-53 4 mg | | | |

TABLE 5

| Molten material | | Molten material | | Molten material | | Molten material | | Molten material | |
|---|---|---|---|---|---|---|---|---|---|
| composition | | composition | | composition | | composition | | composition | |
| Molten material | | Molten material | | Molten material | | Molten material | | Molten material | |
| MHS 8-061 | | MHS 8-052 | | MHS 8-053 | | MHS 8-059 | | MHS 8-065 | |
| Component % by | | Component % by | | Component % by | | Component % by | | Component % by | |
| weight | | weight | | weight | | weight | | weight | |
| HfBr4 | 33.30 | CaI2 | 16.50 | CaI2 | 26.60 | CaI2 | 27.20 | CaI2 | 43.00 |
| InBr | 33.30 | CsI | 22.50 | CsI | 24.20 | CeI3 | 48.10 | DyI3 | 40.00 |
| InBr3 | 33.30 | DyI3 | 61.00 | DyI3 | 49.20 | CsI | 24.70 | NaI | 17.00 |

1. A high pressure discharge lamp, comprising:
a ceramic discharge vessel which contains two electrodes and a metal halide filling in a discharge volume,
wherein the filling contains a starting gas that is selected individually or in mixture from the group of the noble gases,
wherein the filling moreover contains metal halides that are selected individually or in mixture from the group MXn, M being a representative from the group In, Zn, Mg, Mn, Al, Tl, Sn, Sc, Hg and X being a representative from the group I, Br, Cl,
wherein moreover the filling contains a stoichiometric excess of the metallic portion M in relation to MXn,
wherein the concentration of the metallic portion is in the range from 0.1 to 20 mg/cm³.

2. The high pressure discharge lamp as claimed in claim 1, wherein at the same time the filling contains an excess of the associated metal M for each metal halide MXn contained in the filling.

3. The high pressure discharge lamp as claimed in claim 1, wherein the metallic concentration of Hg in the filling is 1 mg/cm³ at most.

4. The high pressure discharge lamp as claimed in claim 1, wherein the filling contains bonded Hg in the form of the halide HgX2.

5. The high pressure discharge lamp as claimed in claim 1, wherein the filling contains at least one of the metal halides NaX, LiX, CaX2.

6. The high pressure discharge lamp as claimed in claim 1, wherein the filling additionally contains at least one halide of a rare earth element SE in the form of SEX3.

7. The high pressure discharge lamp as claimed in claim 1, wherein the ceramic discharge vessel has a starting material on the outer wall.

8. The high pressure discharge lamp as claimed in claim 3,
wherein the metallic concentration of Hg in the filling is 0 mg/cm³.

9. The high pressure discharge lamp as claimed in claim 6,
wherein SE is Ce.
